(19) United States
(12) Patent Application Publication
(10) Pub. No.: US 2002/0194085 A1
(43) Pub. Date: Dec. 19, 2002

(54) Point service system

(75) Inventors: Hitoshi Kageyama, Kanagawa (JP); Toru Kuwahara, Kanagawa (JP); Koji Kishi, Kanagawa (JP); Tetsuya Iida, Saitama (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/164,152

(22) Filed: Jun. 6, 2002

(30) Foreign Application Priority Data
Jun. 7, 2001 (JP) 2001-172286

(51) Int. Cl. G06F 17/60

(52) U.S. Cl. 705/26

(57) ABSTRACT

A store apparatus determines the number of points given to a customer who has purchased a commodity using a customer apparatus via the Internet, in which the number of points are determined based on a roulette game. Since the point value given to the customer who purchases the commodity is determined by the roulette game regardless of the cost of the commodity purchased, the specific time period when purchased or the specific commodity purchased, it is possible to keep the willingness of the customer to purchase commodities and to direct that willingness to all commodities. In addition, since the customer can acquire higher points than the points usually given depending on the result of the roulette game, it is possible to further rouse the willingness of the customer to purchase commodities. Further, the customer is capable of shopping with more fun.

### CROSS-REFERENCE TO RELATED APPLICATIONS

This application claims priority from Japanese Patent Application No. 2001-172286 filed on Jun. 7, 2001, the disclosure of which is hereby incorporated by reference herein.

### BACKGROUND OF THE INVENTION

The present invention relates to a point service system, a method of point service, a point service program and a computer readable recording medium having recorded thereon a point service program, in all of which exchangeable points for various kinds of commodities or services are given to the customer depending on the customer's order of the commodity or the service.

Conventionally, there have been provided for customers many point service systems in which points exchangeable for various kinds of services, such as discounts on commodities, premium exchanges or so forth, are given to a customer depending on the price of the commodity that the customer purchased at a store. According to such systems, whenever the customer orders commodities and/or services, the customer can acquire points depending on the price thereof, so that the more the customer purchases, the more the points increase. Thus, the point service system is capable of enticing the customer to purchase, whereby having been introduced not only in a real store, but also in a virtual store expanded on the Internet, the workings thereof are introduced in network marketing systems.

Meanwhile, in these days, in order to further entice the customer to purchase commodities by utilizing the point service system, improvements have been made in which a greater number of points than normal are given to the customer when the customer purchases a commodity within a specific period or the customer purchases a commodity in combination with a specific campaigned commodity.

According to the improvement described above, however, only the specific period or the specific campaigned commodity is aimed to entice the customer to purchase commodities. As a result, the customer's willingness to purchase commodities is limited to the specific period or the specific campaigned commodity. Accordingly, it is difficult to maintain the customer's willingness to purchase commodities and to direct that willingness to commodities other than the campaigned commodity.

On the other hand, in the above-described conventional point service system, the number of points given to the customer is predetermined at the store side. When the number of points is predetermined, there is entirely no room for the will of the customer to intervene. Accordingly, there is little interest for the customer in the above-described conventional point service system except only for the service brought by the points.

### SUMMARY OF THE INVENTION

The present invention was proposed in consideration of the above-mentioned problems, and an object of the present invention is to provide a point service system, a method for point service, a point service program and a computer readable recording medium having recorded thereon a point service program, all of which are capable of rousing the willingness of the customer to purchase commodities and/or services, and also capable of directing that willingness to all commodities and/or services. Further, the present invention is capable of bringing enjoyment to the customer making the purchases.

In the present invention, the number of points given to the customer who purchases commodities and/or services is changed in accordance with a game-based factor. According to the invention, the value of the points given to the customer is changed regardless of the cost of the commodities purchased. In addition, the customer himself or herself can determine the value of the points with the feel of a game, therefore, this point service makes it possible for the customer to maintain a willingness to purchase commodities and to direct that willingness to all commodities, regardless of a specific time period or a specific commodity. In addition, since the pleasure of determining the number of points is prepared for the customer, the customer is able to shop with more fun.

Other and further objects and features of the present invention will become obvious upon an understanding of the illustrative embodiments about to be described in connection with the accompanying drawings or will be indicated in the appended claims, and various advantages not referred to herein will occur to one skilled in the art upon employing the invention in practice.

### BRIEF DESCRIPTION OF THE DRAWINGS

FIG. 1 is a schematic view illustrating the configuration of an entire network marketing system according to one embodiment of the present invention;

FIG. 2 is a schematic view illustrating the constitution of a store apparatus involved in the network marketing system illustrated in FIG. 1;

FIG. 3 is a schematic view illustrating a data format in a commodity database according to the embodiment of the present invention;

FIG. 4 is a schematic view illustrating a data format in a customer database according to the embodiment of the present invention;

FIG. 5 is a schematic view illustrating a customer apparatus involved in the network marketing system illustrated in FIG. 1;

FIG. 6 is a flowchart illustrating the operation of the network marketing system;

FIG. 7 is a flowchart illustrating an ID registration process according to the embodiment of the present invention;

FIG. 8 is a flowchart illustrating an order process according to the embodiment of the present invention;

FIG. 9 is a schematic view illustrating a roulette participation confirmation image according to the embodiment of the present invention;

FIG. 10 is a schematic view illustrating a roulette operation image according to the embodiment of the present invention;

FIG. 11 is a schematic view for explaining a point giving process according to the embodiment of the present invention; and

FIG. 12 is a schematic view illustrating a point checking image according to the embodiment of the present invention.

### DETAILED DESCRIPTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

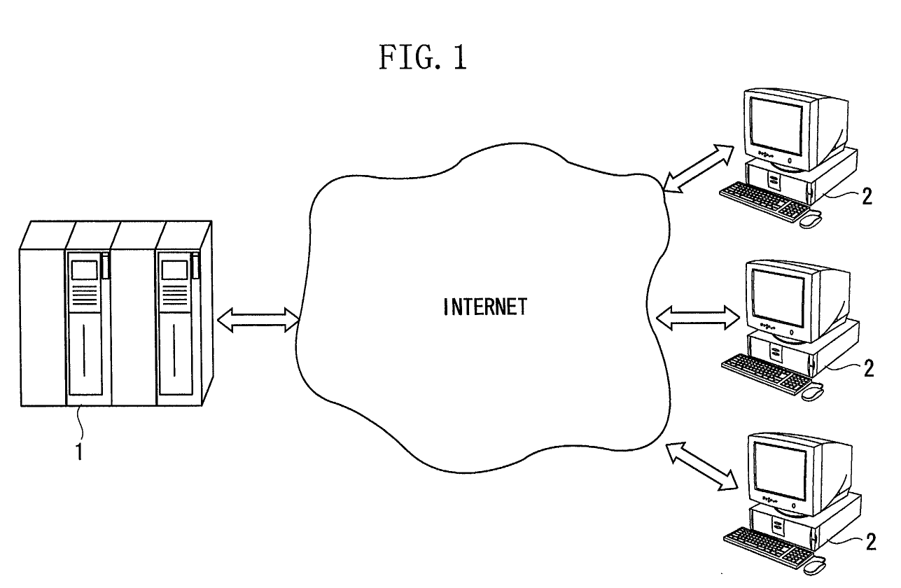

The present invention, for example, as illustrated in FIG. 1, is applicable to a network marketing system in which a customer purchases commodities via the Internet.

### Configuration of Network Marketing System

First of all, the configuration of the network marketing system according to an embodiment of the present invention will be explained with reference to FIG. 1.

The network marketing system according to the embodiment of the present invention is illustrated in FIG. 1, in which a store apparatus 1 and a customer apparatus 2 are connected to each other via the Internet.

The store apparatus 1 involved in the network marketing system is controlled by a store to establish an online shopping mall on the Internet. The online shopping mall may sell not only commodities manufactured by the store itself, but also other commodities.

The customer who is a user of the customer apparatus 2 is capable of accessing the online shopping mall established by the store via the Internet and then ordering commodities that the customer desires to purchase. In order to realize smooth order processing at this time, the store apparatus 1 is capable of obliging the customer to input information, such as an address for delivery, necessary information for payment and so forth, before the customer's utilization of the online shopping mall. The store apparatus 1 controlled by the store receives the customer's order via the Internet and then the store conducts a procedure for delivering the ordered commodity to the customer. In addition, the order includes an advance order.

In order to maintain the customer's willingness to purchase commodities, and to direct it to all commodities that the store deals with, the online shopping mall makes the customer rotate a virtual roulette wheel and then gives points depending on the number indicated by the roulette wheel after shipping the commodity to the customer. The points may be converted into, for example, 1 yen per 1 point in the online shopping mall, wherein the customer can use the points to obtain a discount on the customer's next purchase, which discount will depend on the number of the points, or the customer can exchange the points for a premium commodity corresponding to the predetermined number of points.

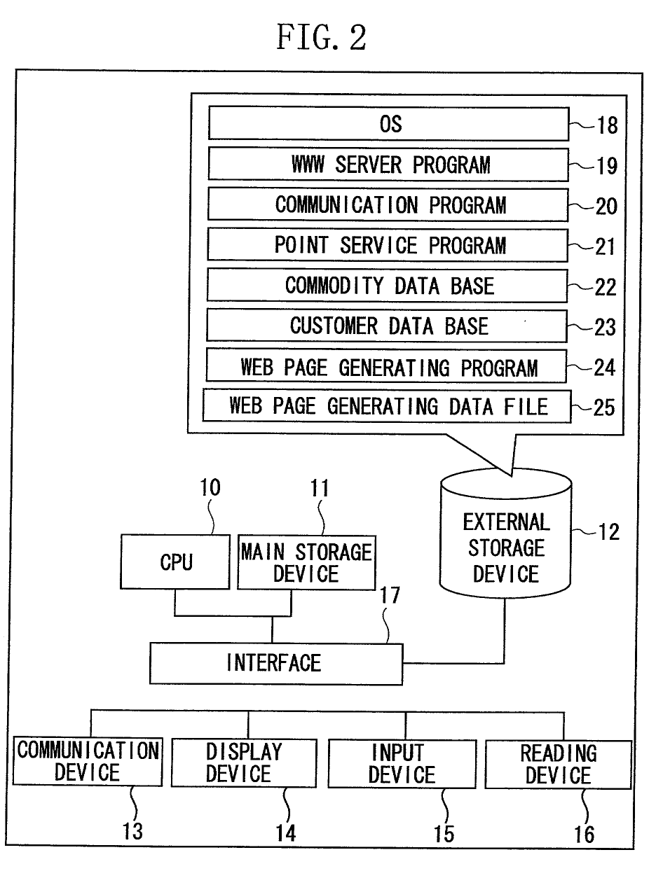

FIG. 2 is a schematic view illustrating the constitution of a store apparatus 1 involved in the network marketing system illustrated in FIG. 1. The constitution of the store apparatus 1 will be described with reference to FIG. 2.

The store apparatus 1, as illustrated in FIG. 2, comprises a CPU 10 (Central Processing Unit; CPU); a main storage device 11; an external storage device 12, such as a hard disk device and so forth; a communication device 13 for communicating with the customer apparatus 2 via the Internet; a display device 14, such as a CRT and so forth; an input device 15, such as a keyboard, mouse and so forth; a reading device 16 for reading data from a portable recording medium, such as a CD-ROM, DVD-ROM and so forth; and an interface 17 for controlling data transmission between the above-described elements.

The external storage device 12 stores therein an OS 18 (OS; Operation System), a WWW server program 19, a communication program 20, a point service program 21, a commodity database 22, a customer database 23, a Web page generating program 24, and a Web page generating data file 25, the respective programs being loaded in the main storage device 11 and then executed by the CPU 10.

The WWW server program 19 is executed by the CPU 10, thereby controlling the store apparatus 1 so as to show data in the form of HTML (Hyper Text Markup Language) so that the customer can peruse the data from the WWW browser of the customer apparatus 2 by utilizing HTTP (Hyper Text Transfer Protocol).

The communication program 20 is executed by the CPU 10, thereby controlling the store apparatus 1 so as to process various kinds of protocols such as, for example, PPP (Point-to-Point Protocol) and/or TCP/IP (Transmission Control Protocol/Internet Protocol) and so forth necessary to conduct communications between the store apparatus 1 and the customer apparatus 2.

The point service program 21 is executed by the CPU 10, thereby controlling the store apparatus 1 so as to determine the points to be given to the customer in accordance with a numeral indicated by the virtual roulette wheel which the customer rotates after shipment of the purchased commodity to the customer.

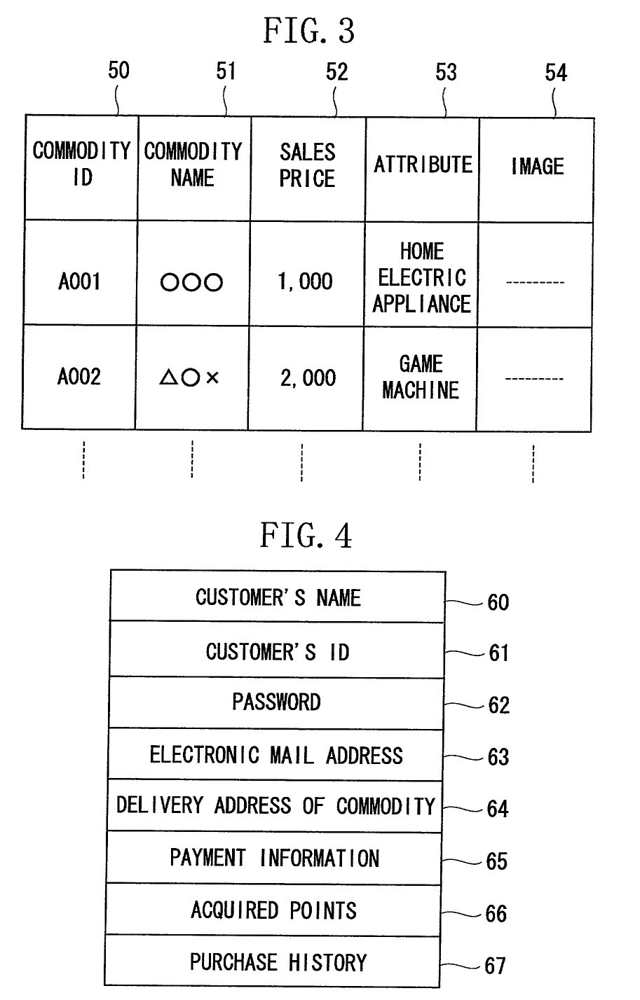

The commodity database 22, as illustrated in FIG. 3, stores therein commodity IDs 50 which are codes for identifying the commodities, commodity names 51, sales prices 52, attributes 53 of the commodities classified into, for example, “home electric appliance”, “game machine”, “software” and so forth, and images 54 for generating images of the commodities, in a state of being associated mutually.

The customer database 23, as illustrated in FIG. 4, stores there in a customer's name 60, customer ID 61, password 62, electronic mail address 63, delivery address of the commodity 64, payment information 65 necessary for payment, such as credit card information and so forth, the number of points 66 acquired by the customer, and the purchase history 67 which records the purchased commodity and purchased date, in a state of being associated mutually.

The Web page generating program 24 is executed by the CPU 10, thereby controlling the store apparatus 1 so as to generate an HTML form-based Web page and so forth on which the commodity appears for sale by referring to the commodity database 22, the Web page generating data file 25 and so forth.

The Web page generating data file 25 stores therein a page file, a template file and so forth in order to generate a Web page.

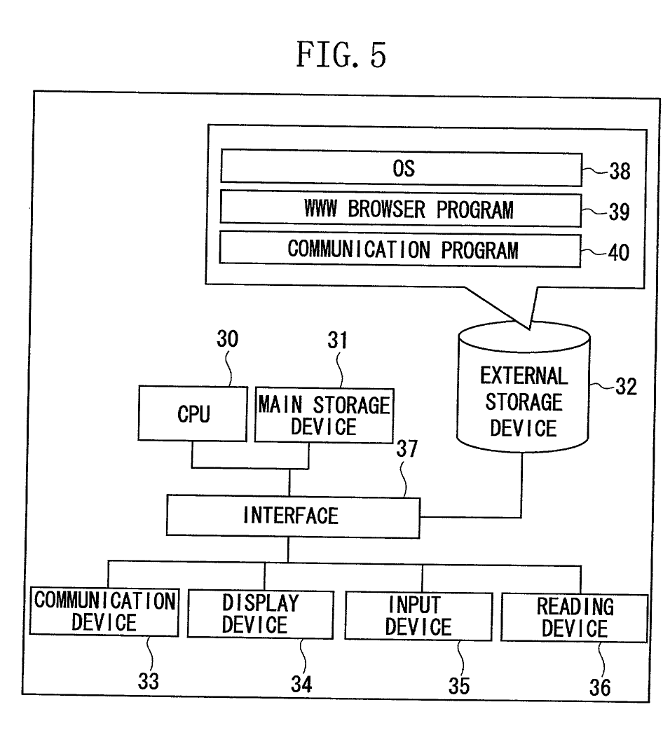

Next, the constitution of the customer apparatus 2 will be described with reference to FIG. 5.

The customer apparatus 2, as illustrated in FIG. 5, comprises a CPU 30; a main storage device 31; an external storage device 32, such as a hard disk device and so forth; a communication device 33 for communicating with the store apparatus 1 via a predetermined network such as, for example, the Internet and so forth; a display device 34, such as a CRT and so forth; an input device 35, such as a keyboard, mouse and so forth; a reading device 36 for reading data from a portable recording medium such as a CD-ROM, DVD-ROM and so forth; and an interface 37 for controlling data transmission between the above-described elements.

The external storage device 32 stores therein an OS 38, a WWW browser program 39 and a communication program 40, the respective programs being loaded in the main storage device 31 and then executed by the CPU 30.

The WWW browser program 39 is executed by the CPU 30, thereby controlling the customer apparatus 2 so that the customer can peruse HTML form-based data, such as Web pages and so forth which the store apparatus 1 opens to the public, by utilizing the HTTP.

The communication program 40 is executed by the CPU 30, thereby controlling the customer apparatus 2 so as to process various kinds of protocols necessary to communicate with the store apparatus 1.

### Operation of Network Marketing System

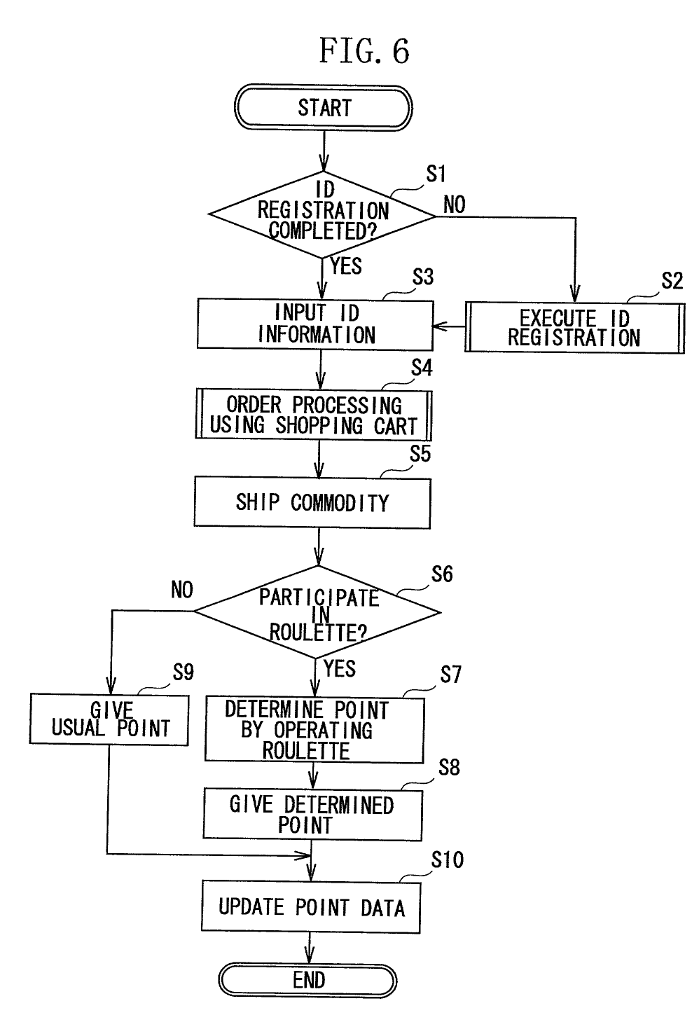

Operations for the case where the customer purchases commodities from the online shopping mall provided by the store apparatus 1 via the customer apparatus 2 will be explained with reference to the flowchart illustrated in FIG. 6.

The flowchart starts when the customer operates the customer apparatus 2 to connect the customer apparatus 2 with the store apparatus 1 via the Internet. The customer then peruses the Web page that the store apparatus 1 has opened to the public on the display device 34 of the customer apparatus 2 to enable the customer to make a commodity purchase, and the commodity purchase processing shifts to step S1.

In step S1, it is determined whether the customer has completed an ID registration on the online shopping mall provided by the store apparatus 1. If the customer has not yet completed an ID registration, the commodity purchase processing shifts to the ID registration processing of step S2.

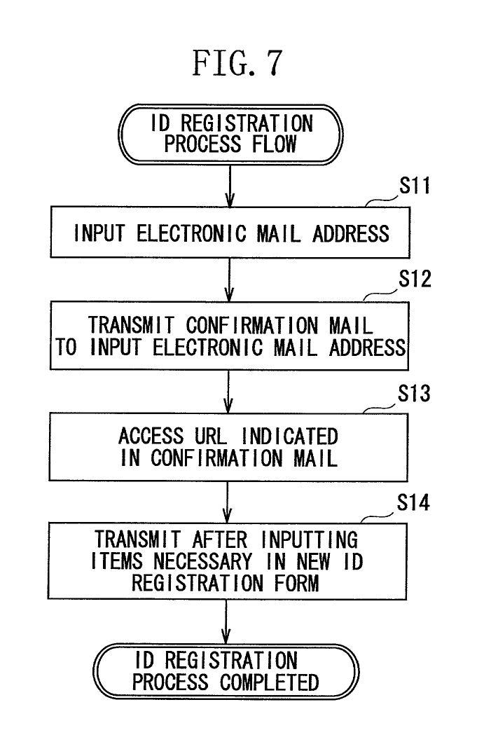

The ID registration processing of step S2 is executed in accordance with the flowchart illustrated in FIG. 7. Hereinafter, the processing of step S2 will be explained with reference to FIG. 7.

The flowchart illustrated in FIG. 7 is started when the customer clicks on a new registration button provided within the Web page. The ID registration processing then shifts to the processing of step S11.

In step S11, the customer inputs an electronic mail address while operating the input device 35 of the customer apparatus 2. After completion of the input of the electronic mail address, the customer apparatus 2 transmits the electronic mail address to the store apparatus 1 by controlling the communication device 33. After the processing of step S11 has been completed, the ID registration processing shifts to the processing of step S12.

In step S12, the store apparatus 1 transmits to the electronic mail address input by the customer a confirmation mail that describes a URL (Universal Resource Locator) for completing the new registration. This processing can determine whether the input electronic mail address is invalid or not correct. The ID registration processing then shifts from step S12 to step S13.

In step S13, the customer receives the confirmation mail transmitted from the store apparatus 1 via the customer apparatus 2, and then accesses the URL in order to complete the new registration, referring to the confirmation mail to output a new ID registration form on the display device 34 of the customer apparatus 2. After the processing of step S13 has been completed, the ID registration processing shifts to step S14.

In step S14, the customer inputs items (name, password, delivery address of commodity, information necessary for payment such as credit card information and so forth) necessary to register an ID by referring to the output new ID registration form. After the items necessary for ID registration have been input, the customer apparatus 2 controls the communication device 33 to transmit the information input by the customer to the store apparatus 1. When it receives the items necessary for the ID registration from the customer apparatus 2, the store apparatus 1 stores the received information in the customer database 23, and then transmits the customer's ID and password to the electronic mail address of the customer. As this completes one series of ID registration processing, processing shifts to step S3 illustrated in FIG. 6, which is the main routine.

On the other hand, if the customer has already completed the ID registration for the online shopping mall, the commodity purchase processing immediately shifts to step S3.

In step S3, the customer inputs the customer's ID and password that are transmitted from the store apparatus 1 while operating the input device 35 associated with the customer apparatus 2. When the customer's ID and password are input by the customer, the customer apparatus 2 transmits the customer's ID and password to the store apparatus 1 by controlling the communication apparatus 33 associated with the customer apparatus 2. The store apparatus 1, when it receives the customer's ID and password from the customer apparatus 2, determines whether the customer's ID and password are correct by referring to the customer database 23, and then, if the customer's ID and password are correct, the commodity purchase processing shifts to the order processing of step S4. On the other hand, if the customer's ID and password are not correct, an error message is transmitted to the customer apparatus 2 in order to prohibit the commodity purchase processing.

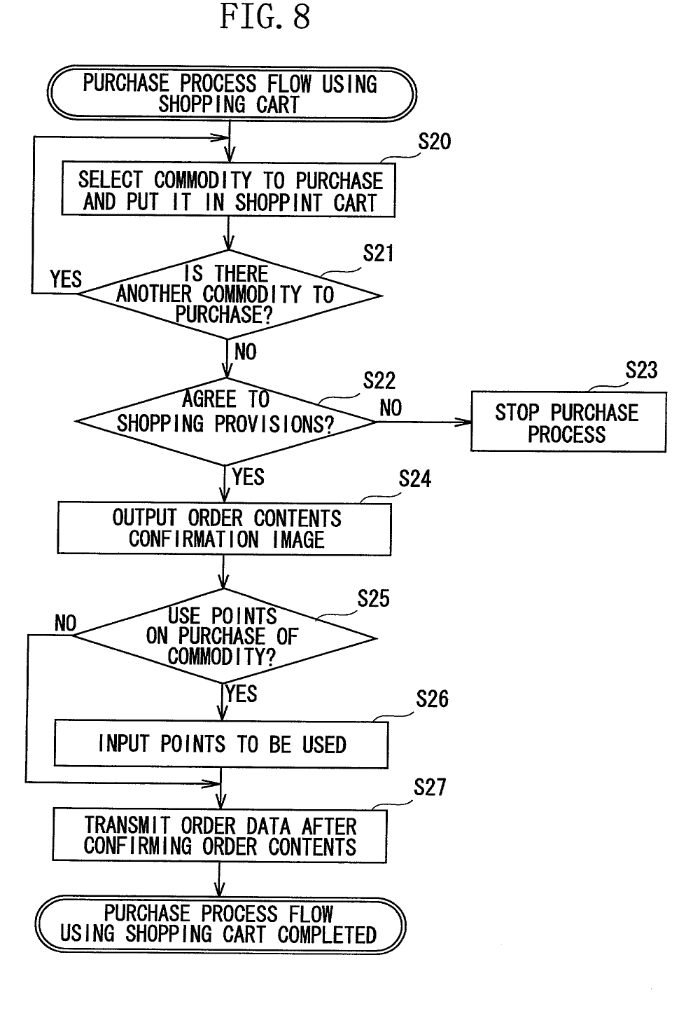

The order processing of step S4 is executed in accordance with the flowchart illustrated in FIG. 8. Hereinafter, the order processing of step S4 will be described with reference to FIG. 8.

The order processing in the flowchart illustrated in FIG. 8 is started when the customer peruses commodity images displayed within the Web page. The order processing then shifts to step S20.

In step S20, the customer selects a commodity to purchase through the input device 35 referring to commodity images within the Web page, and puts the commodity to be purchased into a shopping cart. When the processing of step S20 is completed, the order processing shifts to step S21.

The shopping cart is a data file which is in common use at general online shopping malls, and is for storing therein the name or number of commodities to be purchased. The contents of the data file are displayed to the customer so that the customer is capable of checking the commodities that the customer has selected.

In step S21, the customer determines whether there is another commodity to purchase, and when there is another commodity to purchase, the order processing returns from step S21 to step S20. When there is no other commodity to purchase and the customer desires to purchase the commodities presently within the shopping cart, the order processing shifts from step S21 to step S22.

In step S22, the store apparatus 1 transmits shopping provision information to the customer apparatus 2 in order to confirm whether the customer agrees to the shopping provisions. The customer determines whether he or she agrees to the shopping provisions by referring to the shopping provision information, and when the customer does not agree to the shopping provisions, the customer clicks on a “disagreement” button within the Web page. After that, the order processing shifts from step S22 to step S23.

In step S23, the store apparatus 1 prohibits the customer from purchasing the commodities selected by the customer and then one series of order processing and commodity purchase processing is terminated.

On the other hand, when the customer agrees to the shopping provisions, the customer clicks on an “agreement” button within the Web page. After that, the order processing shifts from step S22 to step S24.

In step S24, the store apparatus 1 prepares an order confirmation image based on the commodities selected by the customer and then transmits the order confirmation image to the customer apparatus 2 by controlling the communication device 13. The customer apparatus 2 displays the order confirmation image on the display device 34, enabling the customer to check whether there is an error in his or her order contents. Further, when there is an error in the order contents, the customer clicks on a “correction” button provided within the order confirmation image to correct the order contents. When the order contents are correct, the purchase processing shifts from step S24 to step S25.

In step S25, the customer determines whether he or she desires to use previously acquired points to purchase the commodities on this occasion. If the user desires to use the points, the order processing shifts from step S25 to step S26.

Here, the store apparatus 1 extracts the number of points the customer has from the customer database 23 so that the customer can check the points which the customer has previously acquired. The store apparatus 1 then displays the extracted number of points within the order confirmation image on the display device 34.

In step S26, the customer inputs the number of points to use to purchase the commodity at a predetermined position within the order confirmation image by operating the input device 35 associated with the customer apparatus 2. When the customer inputs the number of points, the customer apparatus 2 transmits the number of points input by the customer to the store apparatus 1 by controlling the communication device 33. The store apparatus 1, when it receives the number of points transmitted from the customer apparatus 2, calculates a cost by discounting the cost of the commodity purchased at this time according to the number of points used, and then the store apparatus 1 transmits the calculated cost to the customer apparatus 2. After that, the order processing shifts from step S26 to step S27.

In accordance with the above description, each unit of 10 points may be used in commodity purchases, for example, by converting 1 point into 1 yen.

On the other hand, when the customer does not use acquired points to purchase a commodity or the customer does not have acquired points, the order processing immediately shifts from step S25 to step S27.

In step S27, the customer checks the order contents by referring to the order confirmation image and then clicks on an “OK” button provided within the order confirmation image. When the “OK” button is clicked on, the customer apparatus 2 transmits the order data to the store apparatus 1 by controlling the communication device 33. By this processing, one series of order processing is completed, and the commodity purchase processing shifts to step S5 illustrated in FIG. 6, which is the main routine.

In step S5, the store apparatus 1 ships the commodity that is ordered by the customer to the delivery address of the customer, which is stored in the customer database 23, in accordance with the order data transmitted from the customer apparatus 2. Further, after a predetermined time period has elapsed, the store apparatus 1 transmits to an electronic mail address of the customer an electronic mail describing a URL for determining the number of points of the customer accompanying the purchase of the commodity. After that, the commodity purchase processing shifts from step S5 to step S6.

The points are determined by the customer after a predetermined period of time has elapsed from the shipment of the commodity so that the customer does not cancel the purchase of the commodity after finding out the number of points as determined by the use of a roulette wheel, described later. However, when there is no such problem, it doesn't matter whether, for example, the commodity is shipped after the points being given to the customer are determined by the use of the roulette wheel, or whether the electronic mail describing the URL for determining the number of points is transmitted simultaneously with the shipment of the commodity.

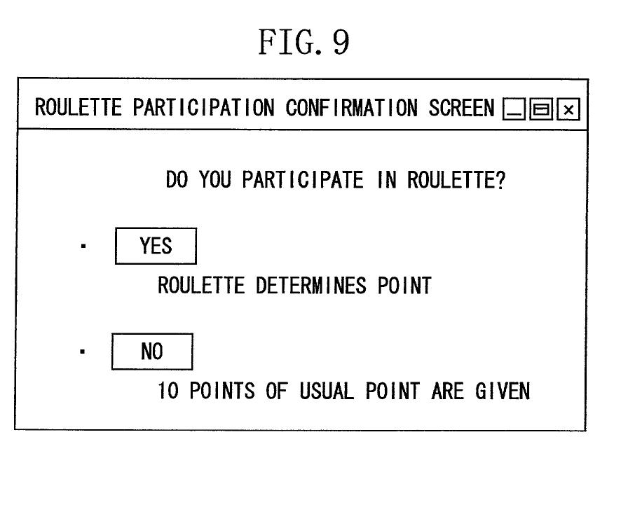

In step S6, the customer accesses the URL for determining the number of points by operating the customer apparatus 2. When being accessed by the customer, the store apparatus 1 outputs a roulette participation confirmation image as illustrated in FIG. 9 on the display device 34 of the customer apparatus 2, and then the store apparatus 1 confirms whether the customer desires to determine the number of points by the use of the roulette wheel. When the customer desires to determine the number of points by the use of the roulette wheel, the customer clicks on a “yes” button provided within the roulette participation confirmation image. After this processing, the commodity purchase processing shifts from step S6 to step S7.

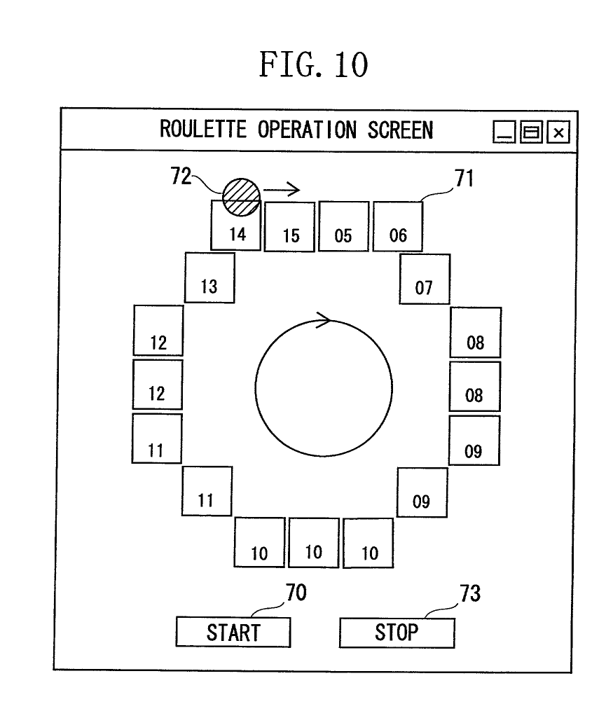

In step S7, the store apparatus 1 outputs a roulette operation image as illustrated in FIG. 10 on the display device 34 associated with the customer apparatus 2. The roulette operation image in this embodiment consists of a roulette wheel 71 on which the number of points available to the customer are displayed, and a ball 72 for determining the number of points to be given to the customer.

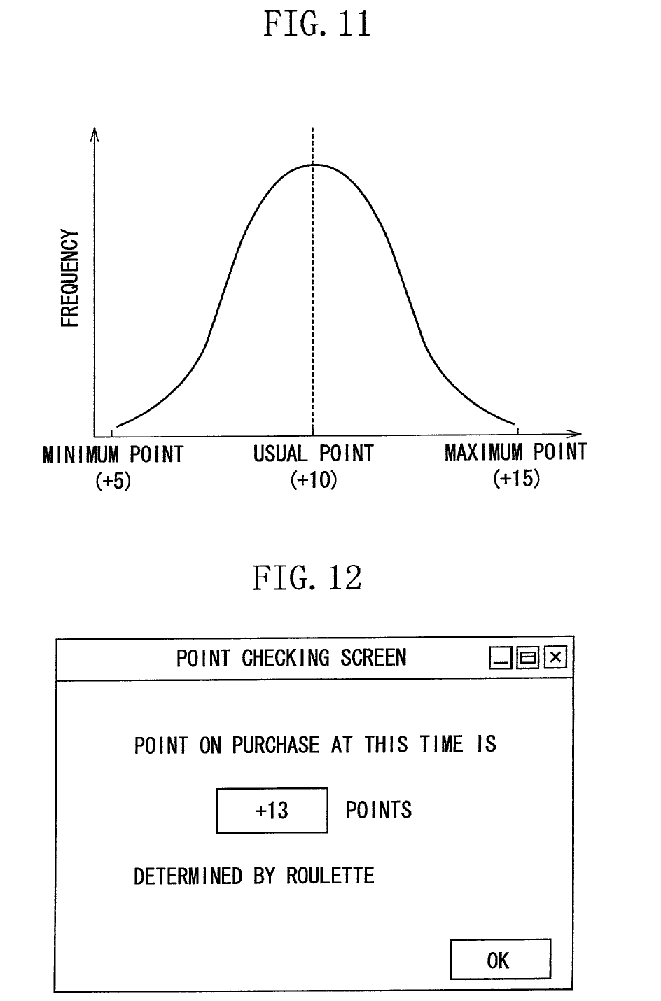

Here, it is appropriate that the number of points displayed on the roulette wheel 71, for example, as illustrated in FIG. 11, may be determined in accordance with a normal distribution formula in which the points (10 points in the case of the example) usually given based on the amount of the commodity purchase is taken as an average value. According to such arrangement, the average value of acquired points for all customers may be made into a usual number of points, so that the store side does not sustain a great deal of loss. On the other hand, it is possible for the customer to acquire more points than the usual number of points. This further encourages the customer to purchase the commodity.

It should be noted that it is preferable to determine the number of points given to the customer in accordance with, for example, a complete probability in which all the numbers of points from the minimum (5 points) to the maximum (15 points) appear with the same probability without employing the normal distribution formula. According to this arrangement, since the number of points given to the customer is completely governed by probability, it is possible to keep the customer's willingness to purchase the commodity and to direct the customer's willingness to purchase the commodity to all of the commodities without being limited to specific time periods and specific commodities. In addition, since the customer can acquire more points than the points usually given, depending on the result of the roulette game, it is possible to further rouse the willingness of customers who participate in the roulette game to purchase the commodity. Further, in view of the pleasure in determining the number of points, the customer is able to shop with more fun.

When the roulette operation image is output on the display device 34, the customer clicks on a “start” button 70 within the roulette operation image to cause rotation of the roulette wheel 71 and the ball 72. The store apparatus 1, when the customer pushes the “start” button 70, outputs an image in which the roulette wheel 71 and the ball 72 are rotated on the display device 34 of the customer apparatus 2.

When the rotation of the roulette wheel 71 and the ball 72 is started, the customer instructs that the rotation of the roulette wheel 71 and the ball 72 be stopped by pushing a “stop” button 73 within the roulette operation image at the appropriate time. After the customer pushes the “stop” button 73, the store apparatus 1 outputs to the display device 34 of the customer apparatus 2, an image in which the rotation speed of the roulette wheel 71 and the ball 72 decrease gradually until the roulette wheel 71 and the ball 72 ultimately stop.

The store apparatus 1 uses the number of the place on the roulette wheel 71 at which the ball 72 is stopped as the number of points to be given to the customer. After that, the commodity purchase processing shifts from step S7 to step S8.

In step S8, the store apparatus 1 outputs a point checking image as illustrated in FIG. 12 on the display device 34 of the customer apparatus 2 to notify the customer of the number of points determined by the use of the roulette game. Further, the store apparatus 1 gives the number of points determined by the use of the roulette game to the customer. After this processing, the commodity purchase processing shifts from step S8 to step S10.

On the other hand, when the customer does not participate in the roulette game to determine the number of points associated with the commodity purchase, the customer clicks on a “no” button provided within the roulette participation confirmation image. After this processing, the commodity purchase processing shifts from step S6 to step S9.

In step S9, the store apparatus 1 gives the customer a number of points (usual points) depending on the amount of the commodity purchased by the customer, referring to the order data transmitted from the customer apparatus 2. After this processing, the commodity purchase processing shifts from step S9 to step S10.

In step 10, the store apparatus 1 updates the acquired number of points of the customer that are stored in the customer database 23 based on the number of points given to the customer in the above-described processing of step S8 or step S9. After that, one series of commodity purchase processing is completed.

As is clear from the above explanation, according to the network marketing system of the embodiment, since the point value given to the customer by purchasing the commodity is determined by a number indicated by the roulette game regardless of the cost of the commodity purchased, the specific time period and the specific commodity, it is possible to keep the customer's willingness to purchase commodities and to direct the willingness of the customer to purchase commodities to all commodities.

In addition, according to the network marketing system of the embodiment, since the customer can acquire more points than the points usually given, depending on the result of the roulette game, it is possible to further rouse the willingness of the customers who participate in the roulette game to purchase commodities. Further, the roulette game provides the customer with pleasure in determining the number of points to be received, therefore enabling the customer to shop with more fun.

### Another Embodiment

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

For example, in the above-described embodiment, a point value to be given to the customer is determined by the use of the roulette game. However, it is possible to determine the point value to be given to the customer by the use of a raffle, bingo, and so forth. In addition, the above-described embodiment describes point giving processing in a virtual store on the Internet. However, the embodiment is also applicable to an actual retail store.

It should be noted that the point service processing of the embodiment might be stored in a computer readable recording medium after the point service processing is programmed. Then, on the execution of the point service processing, the recording medium is made to read in a computer system so that a storage section such as a memory and so forth in the computer system stores therein the program. An operation device then executes the point service program, thereby realizing the point service according to the embodiment of the present invention.

Here, the recording medium includes a computer readable recording medium and so forth, such as, for example, a semiconductor memory, magnetic disk, optical disk, magnetic optical disk, magnetic tape and so forth, that is capable of recording programs.

1. A point service system, comprising:
a receiver operable to receive an input from a user with respect to the user's intention to purchase a commodity or service; and
a first determining unit operable to determine a numerical value that corresponds to a value of the commodity or service,
wherein the numerical value fluctuates stochastically.

2. The point service system according to claim 1, wherein the first determining unit determines the numerical value within a predetermined range of numerical values.

3. The point service system according to claim 1, wherein the first determining unit determines the numerical value in accordance with a normal distribution formula.

4. The point service system according to claim 2, wherein the first determining unit determines the numerical value so that the probability of determining any one of the numerical values within the predetermined range of numerical values is the same.

5. The point service system according to claim 2, wherein the first determining unit determines the numerical value so that the probability of determining any one of the numerical values within the predetermined range of numerical values is based on predetermined distribution rules.

6. The point service system according to claim 1, further comprising:
a notifying unit operable to notify the user who purchases the commodity or service of the numerical value.

7. The point service system according to claim 1, further comprising:
a controller operable to execute numerical value determination by controlling the first determining unit when there is a numerical value determination request from the user.

8. The point service system according to claim 7, further comprising:
a prompting unit operable to prompt the user to input the numerical value determination request.

9. The point service system according to claim 8, wherein the prompting unit prompts the user to input the numerical value determination request by transmitting an electronic mail to the user.

10. The point service system according to claim 1, further comprising:
a second determining unit operable to determine a previously fixed numerical value that corresponds to the value of the commodity or service.

11. The point service system according to claim 10, further comprising:
a switching unit operable to switch between the first and second determining units.

12. A method of point service, comprising:
inputting control information for determining a point value exchangeable for a predetermined commodity or service, wherein the point value is given to a customer who has purchased a commodity or service; and
determining the point value in accordance with the input control information and then giving the determined point value to the customer.

13. The method of point service according to claim 12, further comprising:
fluctuating the point value that is given to the customer with a predetermined probability.

14. The method of point service according to claim 13, further comprising:
giving a fixed point value corresponding to a value of the commodity or service purchased by the customer when the customer does not desire fluctuation of the point value.

15. The method of point service according to claim 13, further comprising:
determining the point value that is given to the customer in accordance with a normal distribution formula in which the point value corresponding to a value of the commodity or service purchased by the customer is taken to be an average value.

16. The method of point service according to claim 13, further comprising:
selecting the point value from a predetermined range of point values, and giving the selected point value to the customer.

17. The method of point service according to claim 12, wherein the point value that is given to the customer is determined a predetermined time period after the customer has purchased the commodity or service.

18. A system of point service, comprising:
a processor for executing instructions; and
instructions, the instructions including:
receiving control information for determining a point value exchangeable for a predetermined commodity or service which is given to a customer who has purchased a commodity or service; and
determining the point value in accordance with the received control information and then giving the determined point value to the customer.

19. A computer-readable recording medium having recorded thereon a point service program to be executed on a computer, the point service program comprising:
receiving control information for determining a point value exchangeable for a predetermined commodity or service which is given to a customer who has purchased a commodity or service; and
determining the point value in accordance with the received control information and then giving the determined point value to the customer.
